(19) United States
(12) Patent Application Publication
(10) Pub. No.: US 2011/0089303 A1
(43) Pub. Date: Apr. 21, 2011

(54) LIGHTWEIGHT SUPPORT FOR PHOTOVOLTAIC FACILITIES

(75) Inventor: BERNHARD BECK, Volkach OT Dimbach (DE)

(73) Assignee: Adensis GmbH, Dresden (DE)

(21) Appl. No.: 12/899,175

(22) Filed: Oct. 6, 2010

(30) Foreign Application Priority Data
Oct. 20, 2009 (DE) 10 2009 049 855.9

(51) Int. Cl. F16M 13/00

(52) U.S. Cl. 248/346.4

(57) ABSTRACT

A lightweight support includes a corrugated base body having an elongated rectangular configuration defining an upper longitudinal rim and a lower longitudinal rim. The base body is composed of a first layer made of metal, a second layer which is made of rigid foam and applied onto the first layer, and a third layer which is made of metal and applied onto the second layer. Stabilization rails are attached to the base body in order to maintain integrity of the lightweight support when subject to stress. The stabilization rails can hereby be placed on or at or integrated in the upper and lower longitudinal rims, respectively.

### CROSS-REFERENCES TO RELATED APPLICATIONS

This application claims the priority of German Patent Application, Serial No. 10 2009 049 855.9, filed Oct. 20, 2009, pursuant to 35 U.S.C. 119(a)-(d), the content of which is incorporated herein by reference in its entirety as if fully set forth herein.

### BACKGROUND OF THE INVENTION

The present invention relates, in general, to a lightweight support, and more particularly to a lightweight support for use as carrier beam for modular rails in photovoltaic facilities.

The following discussion of related art is provided to assist the reader in understanding the advantages of the invention, and is not to be construed as an admission that this related art is prior art to this invention.

Lightweight supports of a type involved here include normally a corrugated base body to serve as roof or wall in building structures. The base body includes a first layer of metal, a second layer of rigid foam applied on the first layer, and a further layer of metal applied on the second layer. The presence of the rigid foam layer, e.g. of polyurethane, provides the base body with a thermal insulation effect and at the same time some mechanical strength so as to be able to install larger boards of several square meters. These boards have not find application to date as a support because of their inability to withstand tensile and compressive forces. In such situations, the corrugation of the base body would undergo a compression, depriving the support of its strength.

In particular in the field of large-scale photovoltaic facilities, wooden beams are currently being used as supports. Wooden beams are however not only relatively heavy and therefore difficult to install, but also expensive.

It would therefore be desirable and advantageous to provide an improved lightweight support to obviate prior art shortcomings.

### SUMMARY OF THE INVENTION

According to one aspect of the present invention, a lightweight support includes a corrugated base body having an elongated rectangular configuration defining an upper longitudinal rim and a lower longitudinal rim, with the base body including a first layer made of metal, a second layer made of rigid foam and applied onto the first layer, and a third layer made of metal and applied onto the second layer, and stabilization rails attached to the upper and lower longitudinal rims, respectively.

The present invention resolves prior art shortcomings by so modifying the base body as to be reliable as base component for a support while still having little specific weight.

According to another advantageous feature of the present invention, the stabilization rails can be placed on or at the upper and lower longitudinal rims.

According to another advantageous feature of the present invention, the stabilization rails can be integrated into a longitudinal end surface of the base body in the area of the longitudinal rims.

When the base body is exposed to a load, the presence of a stabilization rail results in a reinforcement or stiffening of the corrugated structure so that a compression or buckling of the corrugated structure is counteracted to maintain integrity.

In a simplest case, the stabilization rails may be configured as flat sections of metal or plastic which are laterally secured to the upper and lower longitudinal rims of the base body at least on one side. The flat section may also be placed directly onto the free end surface of the base body and, for example, spot-welded. The term “flat section” is to be understood as also including the legs of an angle section.

According to another advantageous feature of the present invention, the stabilization rails may also be configured in the form of a U section of metal or plastic, having legs in surrounding relationship to the respective longitudinal rims on both sides. As an alternative, the legs of the U section may also be embedded in a recess of an end surface of the longitudinal rim by a formfit. Examples of metal include lightweight metal, such as, e.g. aluminum. Examples of plastic include plastics of high strength which may, optionally, contain carbon or even made entirely of carbon. Suitably, the flat section or the legs of the U section are secured, e.g. riveted, to the crests of several corrugations of the base body. Evidently, the crest or apex of a corrugation on one side of the base body is opposed by a wave valley on the other side, when maintaining the viewing direction. When viewing the respective side, it is the apex at the wave crest that faces the viewer and is used to connect the base body and the stabilization rail by suitable fasteners, e.g. rivets.

According to another advantageous feature of the present invention, the U section has a bottom interconnecting the legs, wherein the bottom of at least one of the stabilization rails may be cast with a hardenable, pressure-tight compound. In this way, stability can be further enhanced. The compound may be made, e.g. of synthetic resin, concrete, or concrete with admixed granite powder. Of course, any material may be applicable that is free flowing and is inexpensive, e.g. a body of cast resin impregnated in carbon powder. The compound may also be admixed with foamed spheres, such as polystyrene balls, to further reduce weight without adversely affecting strength.

Within the scope of the invention, any corrugated body may be suitable as base body, like e.g. a trapezoidal field support corrugated in a trapezoidal manner, a zigzag profile having a triangular corrugation, or a box profile having a rectangular corrugation.

According to another advantageous feature of the present invention, the first and third layers may be constructed in the form of a structural board, e.g. a trapezoidally corrugated metal sheet, with the second layer being positioned in-between and glued to the first and third layers. The trapezoidally corrugated metal sheet may hereby have a thickness between 0.2 mm and 2 mm. Currently preferred is a thickness between 0.5 mm and 1 mm. Of course, when using the support for applications other than for photovoltaic facilities, thicker and heavier layers may be used.

According to another advantageous feature of the present invention, two base bodies in parallel side-by-side relationship may be provided, wherein a stabilization rail configured in the form of a U section of metal or plastic may be disposed between the base bodies so that the outside of the opposing upper and/or lower rims are connected to the legs of the U section, respectively. Another variation involves the provision of a wider U section, whereby one base body can be secured to the inside of one leg and the other base body can be secured to the inside of the other leg. The manner of securement between base body and stabilization rail may be realized in a same manner as described above in connection with a lightweight support having only a single base body. When the span width to be bridged is large, the use of a multiplicity of base bodies, e.g. between four and eight, in parallel relationship may be possible which can then be connected by a common stabilization rail of a width of e.g. 1 meter. The common stabilization rail is hereby connected at least to the central base bodies via their end surface.

According to another advantageous feature of the present invention, a permanently elastic compound, e.g. bitumen, may be applied on the hardened compound and partly penetrated by the longitudinal rim(s) of the base body or base bodies. As a result, stress peaks at the force introduction points, i.e. at the longitudinal rims of the base body, are mitigated. The permanently elastic compound may be sprayed onto the hardened compound or a rubber or caoutchouc strip may be inserted into the U section. When the stabilization rail is a flat bar or flat steel bar, one side of the strip should be laminated with the elastic compound beforehand. The permanently elastic compound may be applied at a thickness of 5 mm to 12 mm, with the base body penetrating the permanently elastic compound at a penetration depth between 2 mm and 7 mm. A reverse construction is however also possible, i.e. the permanently elastic compound can be directly applied onto to the bottom of the U section, with the longitudinal end surface of the base body terminating there. An additional hardening layer can then be cast onto the permanently elastic compound.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a top and side perspective view of one embodiment of a lightweight support according to the present invention provided with two stabilizing rails in the form of flat bars;

FIG. 2 is a sectional view of the lightweight support, taken along the line II-II of FIG. 1;

FIG. 3 is a sectional view of the lightweight support, taken along the line III-III of FIG. 2;

FIG. 4 is a sectional view of the lightweight support, taken along the line IV-IV of FIG. 2;

FIG. 5 is a plan view of another embodiment of a lightweight support according to the present invention with a U-shaped stabilizing rail;

FIG. 6 is a sectional view of the lightweight support of FIG. 5, taken along the line VI-VI of FIG. 5;

FIG. 7 is a sectional view of the lightweight support of FIG. 5, taken along the line VII-VII of FIG. 5;

FIG. 8 is a sectional view of the lightweight support of FIG. 6 with a casting compound in the bottom of a U-shaped stabilizing rail;

FIG. 9 is a cutaway top and side perspective view of a lightweight support according to the present invention with two base bodies and outer stabilizing rail of U-shaped configuration;

FIG. 10 is a cutaway top and side perspective view of yet another embodiment of a lightweight support according to the present invention with two base bodies and inner stabilizing rail of U-shaped configuration;

FIG. 11 is a top and side perspective view of yet another embodiment of a lightweight support according to the present invention provided with a stabilization rail in the form of a round bar formfittingly integrated in the longitudinal end surface of a base body;

FIG. 11a is a top and side perspective view of the lightweight support of FIG. 11, with the stabilization rail partly broken away;

FIG. 11b is an enlarged detailed view of the area of the encircled lightweight support in FIG. 11a;

FIG. 12 is a top and side perspective view of still another embodiment of a lightweight support according to the present invention provided with a stabilization rail formfittingly integrated in the longitudinal end surface of a base body;

FIG. 13 is a top and side perspective view of still another embodiment of a lightweight support according to the present invention provided with a plurality of base bodies and a common stabilization rail formfittingly integrated with its bottom side in the longitudinal end surfaces of the base bodies;

FIG. 14 is a top and side perspective view of still another embodiment of a lightweight support according to the present invention provided with a plurality of base bodies and a common stabilization rail formfittingly integrated on the longitudinal end surfaces of the base bodies;

FIG. 15 is a top and side perspective view of still another embodiment of a lightweight support according to the present invention provided with a plurality of base bodies and a common stabilization rail riveted on the upper rims of the base bodies;

FIG. 16 is a top and side perspective view of still another embodiment of a lightweight support according to the present invention provided with a constriction;

FIG. 17 is an end view of the lightweight support of FIG. 16; and

FIG. 18 is an end view of a variation of the lightweight support of FIG. 16.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

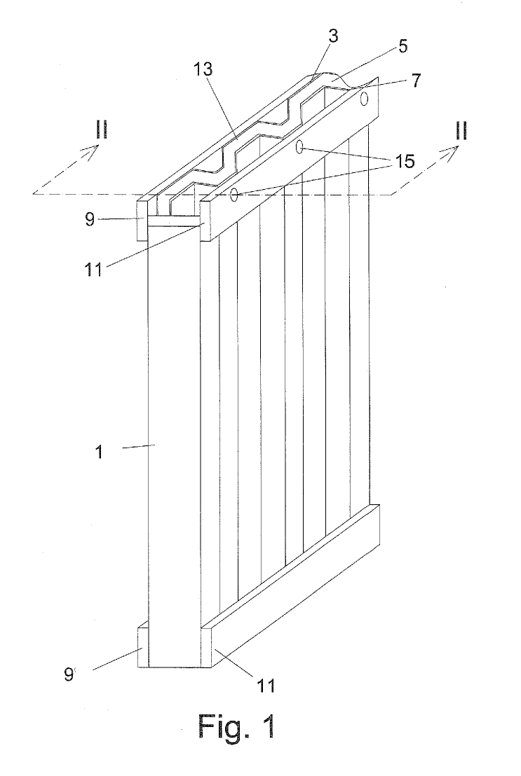

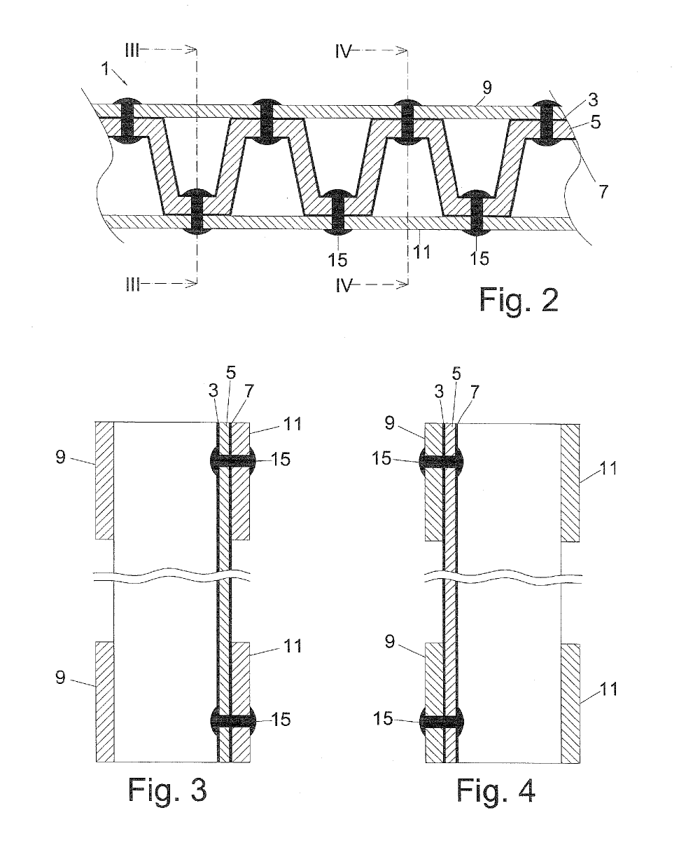

Turning now to the drawing, and in particular to FIG. 1, there is shown a top and side perspective view of one embodiment of a lightweight support according to the present invention. The lightweight support includes a corrugated base body 1 which includes a first layer 3 of metal, a second layer 5 of rigid foam, and a third layer 7 of metal. The base body 1 is cut from a board into the shape of strip of a length which is a multiple of its width, e.g. 5 to 100 times, in particular 10 to 50 times. When the width of the base body 1 is between 10 cm and 40 cm, the strip may thus have a length of several meters. At the lateral longitudinal rim of its upper end, the base body 1 is provided with first and second stabilization rails 9, 11 in the form of flat bands, e.g. a flat bar. Likewise, two further stabilizing rails 9, 11 in the form of flat bands are provided laterally near the lower longitudinal rim of the base body 1 (cf. also FIGS. 2-4). Instead of two flat bands 9, 11, the provision of a single flat band is also conceivable, especially when directly placed and secured to the end surface 13 of the base body 1. The stabilization rails 9, 11 are attached to the base body 1 and secured thereto by rivets 15 (only the rivets 15 on the upper rim are shown for sake of simplicity). The rivets 15 are provided in proximity of the apex of the corrugated base body 1. In the exemplary illustration of FIG. 1, the base body 1 is shaped in the form of a trapezoidal corrugated metal sheet, with the rivets 15 being provided on the outer narrow areas of the base of the trapeze, as shown in FIG. 2. When the lightweight support is exposed to a compressive force and/or a bending force, the forces are dispersed evenly by the flat bands 9, 11 over the length of the base body 1 to prevent in particular a deflection or compression of the base body 1.

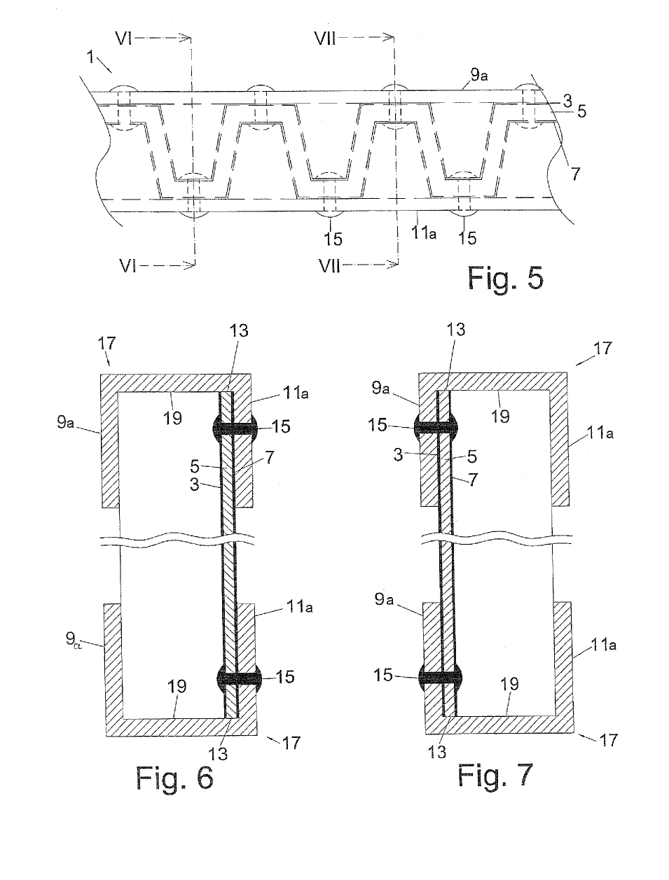

Referring now to FIGS. 5-7, there are shown various views of another embodiment of a lightweight support according to the present invention. Parts corresponding with those in FIG. 1 are denoted by identical reference numerals and not explained again. The description below will center on the differences between the embodiments. In this embodiment, provision is made for a U section 17, instead of the provision of two flat bands. The U section 17 has two legs 9a, 11a and a bottom 19 to interconnect the legs 9a, 11a. FIG. 5 shows hereby a plan view of the lightweight support so that invisible components are depicted by broken lines. The U section 17 is hereby attached to the base body 1 by placing it onto the end surface 13 of the base body 1 and secure it to the base body 1 by rivets 15, shown in particular in FIGS. 6 and 7, and/or glued.

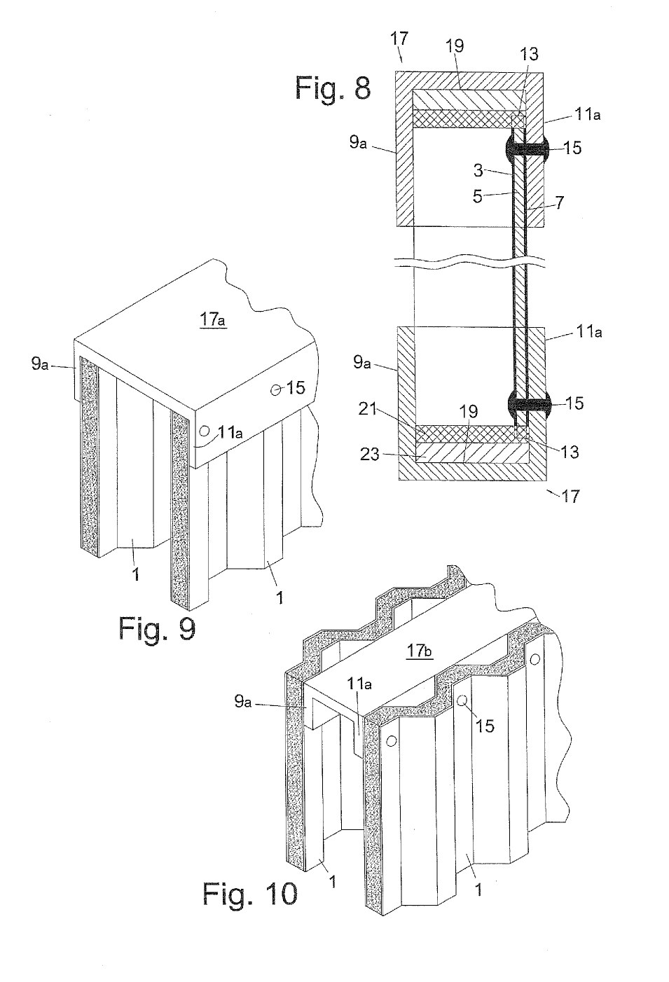

FIG. 8 is a sectional view of a variation of the lightweight support of FIG. 6. In this embodiment, the end surface 13 of the base body 1 ends shy of the bottom 19 of the U section 17 and is embedded in an elastic layer 21, e.g. of bitumen, which in turn is placed upon a casting compound 23 of a hard material, e.g. concrete. It is, of course, also possible to provide only the casting compound 23 of concrete for stabilization of the U section 17 so that the end surface 13 ends shy of the casting compound 23 and thus to prevent introduction of a pressure or tensile stress peaks from the concrete compound into the base body 1. As an alternative, it is also conceivable to eliminate the casting compound entirely so that the end surface 13 of the base body 1 ends within the remaining elastic layer 21.

FIGS. 9 and 10 show variations of a lightweight support with two identical base bodies 1 in parallel spaced apart relationship. In FIG. 9, the base bodies 1 are connected by a stabilization rail 17a of U-shaped configuration. The U section 17a is hereby wider than the U section 17 of the FIGS. 5-7 and embraces the outer rims of the base bodies 1 so that the rims of the base bodies 1 rest against the inner sides of the legs 9a, 11a. FIG. 10 shows the reverse configuration, with U section 17b disposed between the base bodies 1 so that the inner rims of the base bodies 1 rest against the outer surfaces of the legs 9a, 11a of the U section 17b.

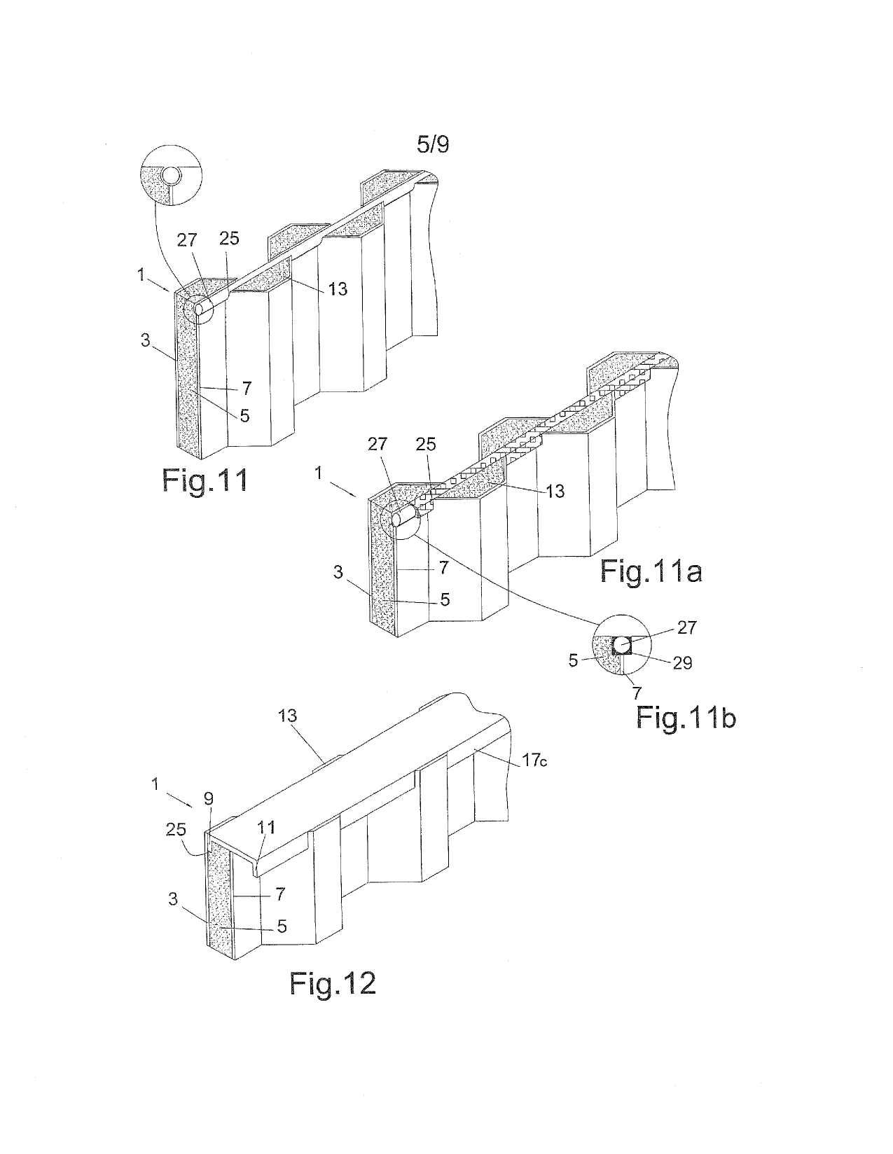

Turning now to FIG. 11, there is shown a top and side perspective view of yet another embodiment of a lightweight support according to the present invention provided with a stabilization rail 27 in the form of a round bar which is formfittingly integrated in the longitudinal end surface 13 of the base body 1. The stabilization rail 27 in the form of a round bar is implemented as a solid steel wire which is placed in a recess 25 (FIG. 11a) that has been milled into the end surface 13 of the base body 1. The stabilization rail 27 is retained in the base body 1, e.g. by means of a glue or by welding. As shown in particular in FIG. 11b, the stabilization rail 27 is laid as reinforcing steel in a concrete bed 29 which is embedded in the end surface 13 of the base body 1. The lower longitudinal rim of the base body 1, although not shown, is stabilized in a same manner. Overall, the lightweight structure thus has superior strength while still being of small weight.

FIG. 12 is a top and side perspective view of a lightweight support according to the present invention provided with a stabilization rail 17c in the form of a U section that is formfittingly integrated in the upper longitudinal end surface 13 of the base body 1. The edges of the left-hand and right-hand upper rim of the base body 1 are hereby stripped to form a recess 25 for the legs 9, 11 of the U-shaped stabilization rail 17c. The recess 25 extends through the rigid foam layer 5 of the base body 1 so as to form a groove that is rectangular in cross section and in which the legs 9, 11 of the U shaped stabilization rail 17c are received by a formfit. The term “formfit” is hereby to be understood as relating to a basic shape of the base body 1 that remains unchanged in the absence of any projecting parts of the stabilization rail.

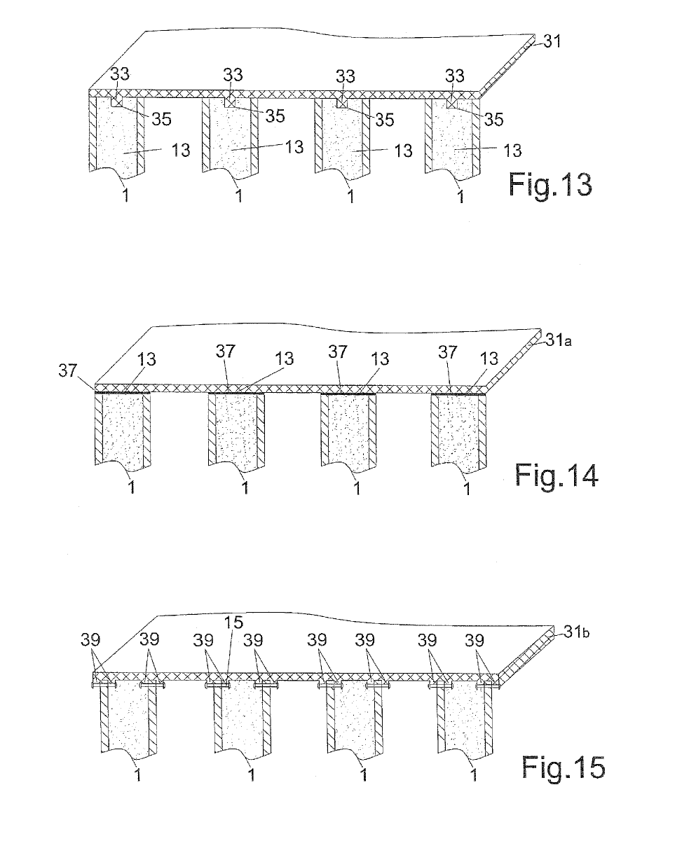

FIG. 13 shows a top and side perspective view of a lightweight support according to the present invention provided with a plurality of base bodies 1 (here four by way of example) and a common stabilization rail 31 which is formfittingly integrated with its bottom side in the longitudinal end surfaces 13 of the base bodies 1. The stabilization rail 31 has a bottom side which is provided with four protrusions 33 in parallel relationship for securement of the stabilization rail 31 to the base bodies 1, with the protrusions 33 being received in four grooves 35 that are formed in the base bodies 1 in opposite disposition to the protrusions 33. The protrusions 33 are suitably glued in the grooves 35.

FIG. 14 shows a variation of a lightweight support with four base bodies 1 and a common stabilization rail 31a which is formfittingly connected on the longitudinal end surfaces 13 of the base bodies 1. From a technical standpoint, this embodiment is the least complicated, compared to other variations of lightweight support having several base bodies because the stabilization rail 31a is configured as a flat strip-like steel board which has a bottom side that is simply glued to the end surfaces 13 of the base bodies 1 by means of an adhesive layer 37.

FIG. 15 shows a lightweight support with four base bodies 1 and a common stabilization rail 31b which is riveted to the base bodies 1. The stabilization rail 31b is also configured as a strip-shaped board and has a bottom side formed with eight double-webs 39 in parallel relationship, with two double-webs 39 respectively forming a pair. The base bodies 1 are respectively positioned between the webs 39 of a pair and connected with the stabilization rail 31b by rivets 15.

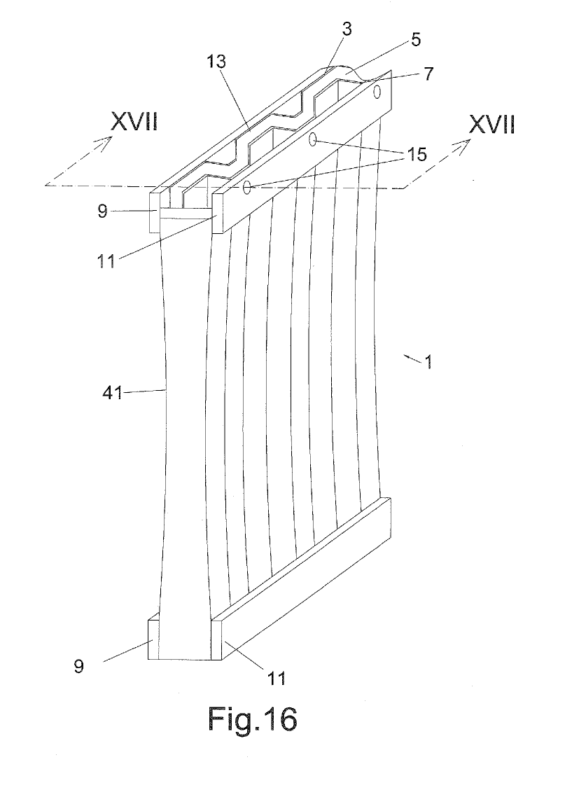

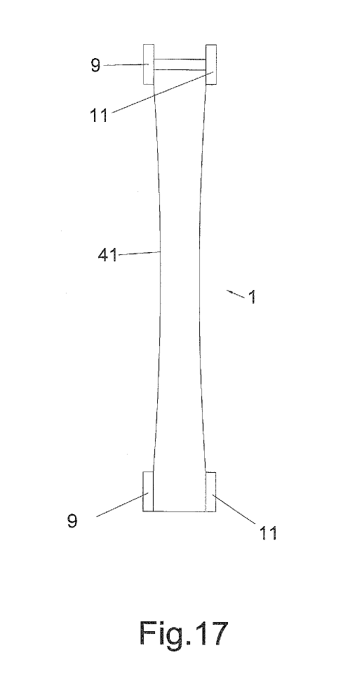

FIGS. 16 and 17 show a variation of the lightweight support of FIG. 1. In this embodiment, the base body 1 of the lightweight support is provided in midsection, especially in the center thereof, with a constriction 41. For ease of illustration and understanding, the constriction is shown here exaggerated. In reality, the constriction 41 is only several millimeters, e.g. between 1 and 5 mm and is intended to oppose a bending or buckling of the lightweight support when subject to particular high loads. The constriction 41 defines hereby a preferred direction in which the trapezoidally corrugated metal sheet that forms the first metal layer 3 is able to deflect or yield. As shown in FIG. 16, the constriction 41 has a concave shape so that bending forces are directed inwardly onto the rigid foam layer 5. As the other trapezoidally corrugated metal sheet that forms the metal layer 7 applies a same force from the other side inwards in opposition, the base body 1 retains its shape.

The constriction 41 is produced by foaming initially the midsection of the base body 1 with the constriction 41. Once the foam has hardened and a certain degree of hardness has been reached so that the material is no longer free-flowing, both longitudinal rims are foamed from atop and below under pressure sized to cause a slight increase in the distance between the trapezoidally corrugated metal sheets 3, 7.

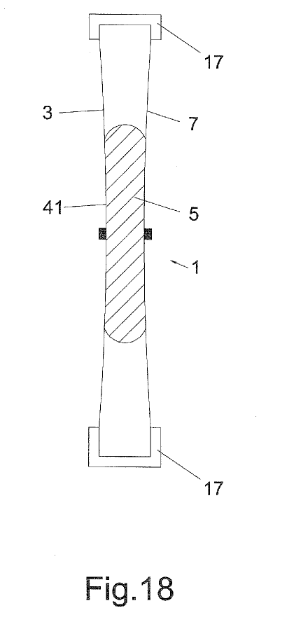

FIG. 18 is an end view of a variation of the lightweight support of FIG. 16. In the embodiment of FIG. 18, the upper and lower longitudinal rims of the base body 1 are stiffened with a U-shaped stabilization rail 17 as opposed to the presence of two flat bars 9, 11, as shown in FIG. 16.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated. For example, combinations of various features, such as, e.g. embedment of stabilization rail in the end surface of a base body, riveting, disposition of the stabilization rail, constriction, etc, may also be applicable. In addition, it is, of course, also possible to employ different configurations for the upper and lower longitudinal rims so long as the longitudinal rims are provided with a stabilization rail.

What is claimed as new and desired to be protected by Letters Patent is set forth in the appended claims and includes equivalents of the elements recited therein:

What is claimed is:

1. A lightweight support, comprising:
a corrugated base body having an elongated rectangular configuration defining an upper longitudinal rim and a lower longitudinal rim, said base body including a first layer made of metal, a second layer made of rigid foam and applied onto the first layer, and a third layer made of metal and applied onto the second layer; and
stabilization rails attached to the upper and lower longitudinal rims, respectively.

2. The lightweight support of claim 1, wherein the stabilization rails are placed on or at the upper and lower longitudinal rims.

3. The lightweight support of claim 1, wherein the stabilization rails are integrated into a longitudinal end surface of the base body in the area of the longitudinal rims.

4. The lightweight support of claim 1, wherein each stabilization rail is configured as a member selected from the group consisting of flat section, round section, and angle section, said member being made of a material selected from the group consisting of metal, carbon fiber, and plastic, said stabilization rail being integrated at least on one side of the longitudinal rim.

5. The lightweight support of claim 4, wherein the stabilization rails is integrated at least on an end surface of the longitudinal rim.

6. The lightweight support of claim 1, wherein the stabilization rails are each configured in the form of a U section of metal or plastic, said U section having legs in surrounding relationship to the longitudinal rim or received in a recess of an end surface face of the longitudinal rim by a formfit.

7. The lightweight support of claim 1, wherein the stabilization rail is configured as a flat section riveted to crests of several corrugations of the base body.

8. The lightweight support of claim 6, wherein the legs of the U section are riveted to crests of several corrugations of the base body.

9. The lightweight support of claim 6, wherein the U section of each stabilization rail has a bottom interconnecting the legs, wherein the bottom of at least one of the stabilization rails is cast with a hardenable, pressure-tight compound.

10. The lightweight support of claim 9, wherein the compound is a material selected from the group consisting of synthetic resin, concrete, and concrete with admixed granite powder

11. The lightweight support of claim 1, wherein the base body is a trapezoidal field carrier which is corrugated in a trapezoidal manner.

12. The lightweight support of claim 1, comprising two of said base body in parallel side-by-side relationship, said stabilization rail being configured in the form of a U section of metal or plastic and disposed between the base bodies, with one leg of the U section resting against an inside of the longitudinal rim of one of the base bodies and another leg of the U section resting against an inside of the longitudinal rim of the other one of the base bodies.

13. The lightweight support of claim 1, wherein the first and third layers are constructed in the form of a trapezoidally corrugated metal sheet, with the second layer being positioned in-between and glued to the first and third layers.

14. The lightweight support of claim 13, wherein the trapezoidally corrugated metal sheet has a thickness between 0.2 mm and 2 mm.

15. The lightweight support of claim 13, wherein the trapezoidally corrugated metal sheet has a thickness between 0.5 mm and 1 mm.

16. The lightweight support of claim 9, further comprising a permanently elastic compound applied on the hardenable compound and penetrated by an end surface of the base body.

17. The lightweight support of claim 16, wherein the permanently elastic compound is bitumen.

18. The lightweight support of claim 16, wherein the permanently elastic compound is applied at a thickness of 5 mm to 12 mm, with the base body penetrating the permanently elastic compound at a penetration depth between 2 mm and 7 mm.

19. The lightweight support of claim 1, comprising a plurality of said base body, said stabilization rail being sized for joint placement on the plurality of said base body.

20. The lightweight support of claim 6, wherein the base body has a strip-shaped configuration, said U section having a bottom interconnecting the legs, further comprising a permanently elastic compound in which a longitudinal end face of the base body terminates.

21. The lightweight support of claim 1, wherein the base body has a constriction in cross section.

22. The lightweight support of claim 21, wherein the constriction is provided in midsection of the base body.
